(19) United States
(12) Patent Application Publication
(10) Pub. No.: US 2024/0249382 A1
(43) Pub. Date: Jul. 25, 2024

(54) IMAGE PROCESSING DEVICE AND PIXEL INTERPOLATION METHOD

(71) Applicant: SK hynix Inc., Icheon-si Gyeonggi-do (KR)

(72) Inventors: Dong Gyun KIM, Icheon-si Gyeonggi-do (KR); Jeong Yong SONG, Icheon-si Gyeonggi-do (KR); Jae Yoon YOO, Icheon-si Gyeonggi-do (KR); Bo Ra LEE, Icheon-si Gyeonggi-do (KR)

(73) Assignee: SK hynix Inc., Icheon-si Gyeonggi-do (KR)

(21) Appl. No.: 18/358,641

(22) Filed: Jul. 25, 2023

(30) Foreign Application Priority Data
Jan. 25, 2023 (KR) 10-2023-0009529

(51) Int. Cl. G06T 3/40; G06V 10/25; G06V 10/56; G06V 10/75

(52) U.S. Cl. CPC G06T 3/4007; G06V 10/25; G06V 10/56; G06V 10/751

(57) ABSTRACT

An image processing device, and a pixel interpolation method, includes a preprocessor configured to generate a region of interest having a preset size based on pixel values received from an image sensor including white pixels and configured to determine an interpolation direction in the region of interest. The image processing device and interpolation method also includes a pixel interpolator configured to determine a second target pixel corresponding to the interpolation direction based on a first target pixel included in the region of interest and configured to calculate an interpolated white pixel value of the first target pixel based on a ratio of pixel values of adjacent white pixels adjacent to the first target pixel and the second target pixel to pixel values corresponding to a color of the first target pixel.

### CROSS-REFERENCE TO RELATED APPLICATION

The present application claims priority under 35 U.S.C. § 119(a) to Korean patent application number 10-2023-0009529 filed on Jan. 25, 2023, in the Korean Intellectual Property Office, the entire disclosure of which is incorporated by reference herein.

### BACKGROUND

### 1. Technical Field

Various embodiments of the present disclosure generally relate to an image processing device, and more particularly, to an image processing device and a pixel interpolation method.

### 2. Related Art

Generally, image sensors may be classified into a charge coupled device (CCD) image sensor and a complementary metal oxide semiconductor (CMOS) image sensor. Recently, the CMOS image sensor, which has low manufacturing cost, has low power consumption, and facilitates integration with a peripheral circuit, has attracted attention.

An image sensor included in a smartphone, a tablet PC, or a digital camera may acquire image information of an external object by converting light reflected from the external object into an electrical signal. An image processing device may perform an image processing operation based on pixel values received from the image sensor.

The colors of pixels included in the image sensor may be preset. The image processing device may perform an interpolation operation of calculating a pixel value corresponding to a color different from the color of a pixel based on the pixel values of neighboring pixels disposed near the corresponding pixel. The pixel values used for the interpolation operation may vary with an interpolation direction. The image processing device may acquire pixel values corresponding to a plurality of colors for one pixel by performing the interpolation operation.

### SUMMARY

Various embodiments of the present disclosure are directed to an image processing device and a pixel interpolation method, which determine an interpolation direction in a preset region of interest, determine target pixels corresponding to the interpolation direction, and calculates an interpolated pixel value based on the ratio of the pixel values of target pixels and adjacent pixels adjacent to the target pixels, thus enabling an interpolation operation to be performed even though pixel values to be used for an interpolation operation are not present in the interpolation direction.

In accordance with an embodiment of the present disclosure is an image processing device. The image processing device may include a preprocessor configured to generate a region of interest having a preset size based on pixel values received from an image sensor including white pixels and configured to determine an interpolation direction in the region of interest. The image processing device may also include a pixel interpolator configured to determine a second target pixel corresponding to the interpolation direction based on a first target pixel included in the region of interest and to calculate an interpolated white pixel value of the first target pixel based on a ratio of pixel values of adjacent white pixels adjacent to the first target pixel and the second target pixel to pixel values corresponding to a color of the first target pixel.

In accordance with an embodiment of the present disclosure is an image processing device. The image processing device may include a preprocessor configured to generate a region of interest having a preset size based on pixel values received from an image sensor including white pixels and configured to determine a diagonal interpolation direction in the region of interest among preset diagonal directions. The image processing device may also include a pixel interpolator configured to determine a second target pixel corresponding to the diagonal interpolation direction based on a first target pixel included in the region of interest and configured to calculate an interpolated white pixel value of the first target pixel based on a ratio of a first summed pixel value of adjacent white pixels adjacent to the first target pixel and the second target pixel to a second summed pixel value of the first target pixel and the second target pixel.

In accordance with an embodiment of the present disclosure is a white pixel interpolation method. The white pixel interpolation method may include: determining a diagonal interpolation direction among preset diagonal directions in a region of interest based on gradient values in the preset diagonal directions; determining a second target pixel corresponding to the diagonal interpolation direction based on a first target pixel included in the region of interest; converting a pixel value of the second target pixel into a conversion pixel value corresponding to a color of the first target pixel; and calculating an interpolated white pixel value of the first target pixel based on a ratio of a first summed pixel value that is a sum of pixel values of adjacent white pixels adjacent to the first target pixel and the second target pixel to a second summed pixel value that is a sum of the pixel value of the first target pixel and the conversion pixel value.

### BRIEF DESCRIPTION OF THE DRAWINGS

FIG. 1 is a diagram illustrating an image processing device according to an embodiment of the present disclosure.

FIG. 2 is a diagram for describing a pixel interpolation operation.

FIG. 3 is a diagram for describing an interpolation direction for a pixel interpolation operation.

FIG. 4 is a diagram for describing a pixel arrangement of an image sensor including white pixels.

FIG. 5 is a diagram illustrating an image processing device for calculating an interpolated white pixel value according to an embodiment of the present disclosure.

FIG. 6 is a diagram for describing a white pixel interpolation operation corresponding to a diagonal interpolation direction in a region of interest according to an embodiment of the present disclosure.

FIG. 7 is a flowchart illustrating a method of calculating an interpolated white pixel value according to an embodiment of the present disclosure.

FIG. 8 is a block diagram illustrating an electronic device including an image processing device according to an embodiment of the present disclosure.

### DETAILED DESCRIPTION

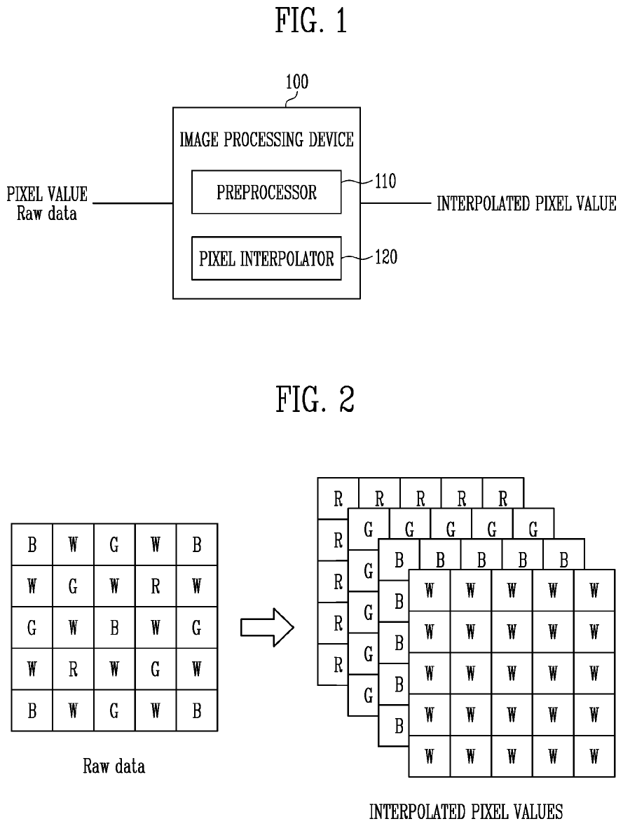

FIG. 1 is a diagram illustrating an image processing device according to an embodiment of the present disclosure.

Referring to FIG. 1, an image processing device 100 may perform an image processing operation based on pixel values received from an external device. In an embodiment of the present disclosure, the external device may be an image sensor. The image processing device 100 may output interpolated pixel values. The pixel values received by the image processing device 100 may be raw data on which an image processing operation is not performed.

The image sensor may include white pixels as well as green pixels, red pixels, and blue pixels. Each of the pixels may include a color filter, and the color of the corresponding pixel may refer to the color of the color filter. Because the colors of pixels included in the image sensor are preset depending on the arrangement of the pixels, the raw data may include pixel values, indicating one color and one piece of brightness information per pixel.

To represent an image via a display or the like, pixel values of a plurality of colors may be required in one pixel. The image processing device 100 may generate interpolated pixel values by performing a pixel interpolation operation based on pixel values. The image processing device 100 may perform a pixel interpolation operation by converting pixel values even in the case where pixel values to be used for the pixel interpolation operation depending on an interpolation direction are insufficient. The image processing device 100 may include a preprocessor 110 and a pixel interpolator 120 for performing a pixel interpolation operation in a diagonal direction.

The preprocessor 110 may generate a region of interest having a preset size based on the pixel values received from the image sensor. The region of interest may be generated to have various sizes and shapes based on the arrangement of the pixels included in the image sensor. The preprocessor 110 may determine an interpolation direction in the region of interest among a plurality of interpolation directions. In an embodiment of the present disclosure, it may be assumed that the preprocessor 110 determines any one of diagonal directions to be the interpolation direction.

The pixel interpolator 120 may perform a white pixel interpolation operation of converting the pixel value of a non-white pixel into the pixel value of a white pixel. The pixel interpolator 120 may determine a first target pixel and a second target pixel included in the region of interest. The pixel interpolator 120 may determine the second target pixel corresponding to the interpolation direction based on the first target pixel on which the pixel interpolation operation is performed. In an embodiment of the present disclosure, the pixel interpolator 120 may perform a white interpolation operation in a diagonal direction.

FIG. 2 is a diagram for describing a pixel interpolation operation.

Referring to FIG. 2, an image processing device may interpolate pixel values generated by an image sensor. When a pixel interpolation operation is performed, each pixel may correspond to a plurality of pixel values. That is, one pixel may correspond to a red pixel value, a green pixel value, a blue pixel value, and a white pixel value.

The image processing device may perform a red interpolation operation in which all pixels correspond to red pixel values based on raw data. Similarly, the image processing device may perform a green interpolation operation, a blue interpolation operation, and a white interpolation operation.

A color pixel value ratio, which is the ratio of a red pixel value, a green pixel value, a blue pixel value, and a white pixel value of the pixel on which the pixel interpolation operation is performed, may be similar to the color pixel value ratio of each of adjacent pixels. For example, when the ratio of the red pixel value, the green pixel value, the blue pixel value, and the white pixel value of a first pixel included in the image sensor is 1:1:1:1, the color pixel value ratio of the a second pixel adjacent to the first pixel may also be 1:1:1:1. In an embodiment of the present disclosure, the image processing device may perform a white interpolation operation on the assumption that the color pixel value ratios of respective pixels are identical to each other.

In FIG. 2, although the image sensor is illustrated as including red pixels, green pixels, blue pixels, and white pixels, this is only an embodiment, and the image sensor may include pixels of various colors, such as magenta pixels or cyan pixels.

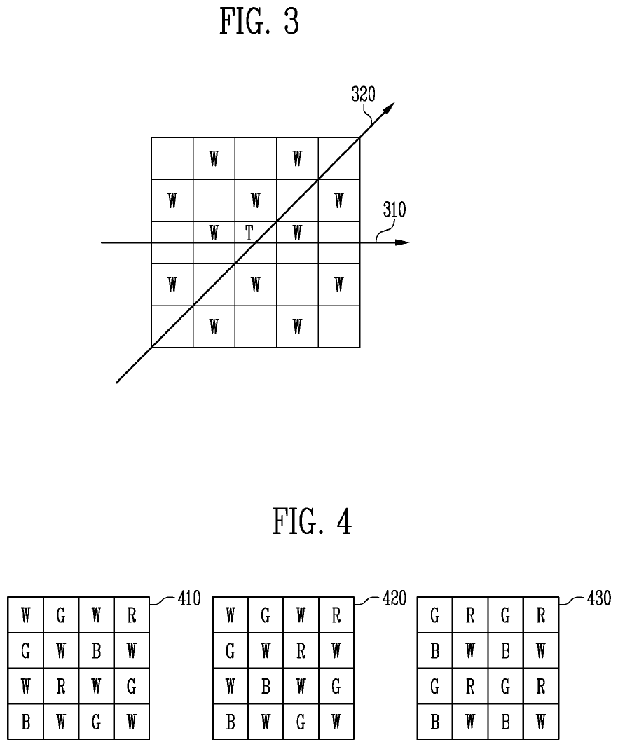

FIG. 3 is a diagram for describing an interpolation direction for a pixel interpolation operation.

Referring to FIG. 3, a white interpolation operation may be performed on a target pixel T depending on an interpolation direction. The target pixel T may be a green pixel, a red pixel, or a blue pixel. In FIG. 3, an image having a 5*5 size is illustrated as an example. Among the pixels included in the image, white pixels may be indicated by W.

The interpolation direction of the image having a 5*5 size may be assumed to be an eastward or left-to-right direction 310. The image processing device may perform a white interpolation operation in the eastward direction 310. In FIG. 3, the number of white pixels corresponding to the eastward direction 310, among white pixels adjacent to the target pixel T, may be 2. The image processing device may determine the average pixel value of two white pixels corresponding to the eastward direction 310 to be the interpolated white pixel value of the target pixel T. Similarly, the image processing device may calculate the interpolated white pixel value of the target pixel T even when the interpolation direction of the image is a westward direction, a northward direction, or a southward direction.

The interpolation direction of the image may be a diagonal direction depending on the directionality of the image. For example, the interpolation direction of an image having a 5*5 size may be assumed to be the northeast or lower left to upper right direction 320. To perform a white interpolation operation on the target pixel T in the northeast direction 320, white pixels corresponding to the northeast direction 320 are required, but white pixels corresponding to the northeast direction 320 might not be present depending on the arrangement of white pixels included in the image sensor.

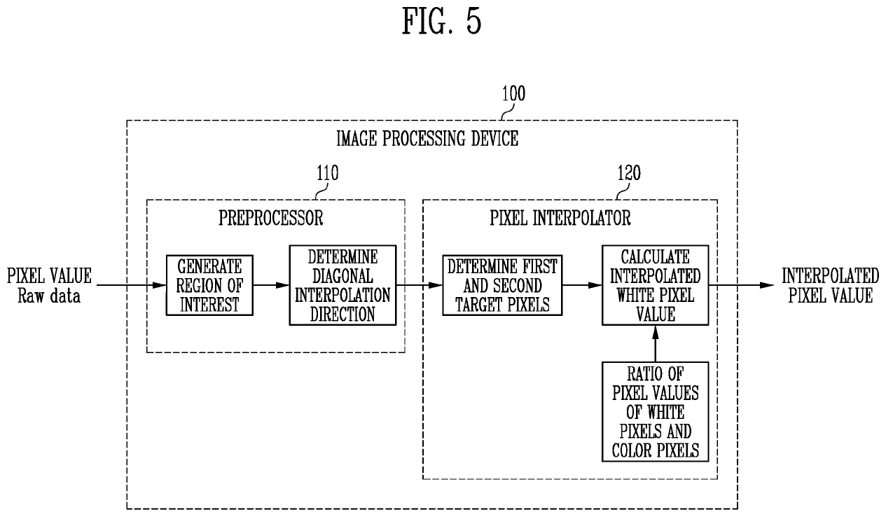

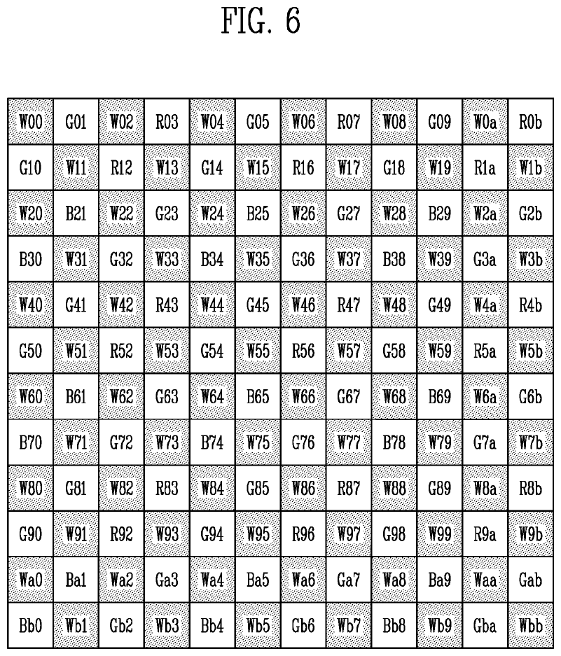

In an embodiment of the present disclosure, when there are no white pixels to be used for a white interpolation operation corresponding to the interpolation direction, the image processing device may calculate the interpolated white pixel value of the target pixel based on the ratio of a summed pixel value of white pixels located near the target pixel T to a summed pixel value of pixels corresponding to the color of the target pixel T. A detailed calculation method will be described in detail later with reference to FIGS. 5 and 6.

In FIG. 3, when the interpolation direction is determined to be a diagonal direction, white pixels to be used for a white interpolation operation might not be present. For example, there might be no white pixels corresponding to the northwest direction, the southeast direction, or the southwest direction of the target pixel T. In an embodiment of the present disclosure, a white interpolation operation may be performed in a diagonal interpolation direction based on the ratio of the pixel values of pixels corresponding to the color of the target pixel T to the pixel values of white pixels.

FIG. 4 is a diagram for describing a pixel arrangement of an image sensor including white pixels.

Referring to FIG. 4, patterns 410, 420, and 430 in which white pixels and color pixels are arranged may be illustrated. The pixels included in the image sensor may be arranged in forms in which the patterns 410, 420, and 430 are repeated. The patterns 410, 420, and 430 illustrated in FIG. 4 are only embodiments, and embodiments of the present disclosure are not limited thereto. The embodiment of the present disclosure may be applied to pixel values corresponding to a pattern in which white pixels are not arranged in a diagonal direction, among the pixel arrangement patterns of the image sensor including white pixels.

In the first pattern 410 and the second pattern 420, the ratio of white pixel values to color pixels may be 50%. In the first pattern 410 and the second pattern 420, an arrangement of red pixels and an arrangement of blue pixels may be different from each other. In the third pattern 430, the ratio of white pixels to color pixels may be 25%.

Because each of the first pattern 410, the second pattern 420, and the third pattern 430 has at least one diagonal direction in which white pixels are not arranged, the embodiment of the present disclosure may be applied to the image processing device which receives pixel values from the image sensor including pixels arranged in the first pattern 410, the second pattern 420, and the third pattern 430.

FIG. 5 is a diagram illustrating an image processing device for calculating an interpolated white pixel value according to an embodiment of the present disclosure.

Referring to FIG. 5, the image processing device 100 may interpolate the pixel value of a color pixel as an interpolated white pixel value based on pixel values received from the image sensor. The pixel values received by the image processing device 100 may be raw data on which a pixel interpolation operation is not performed. It may be assumed that the image sensor includes white pixels and that, for the white pixels and color pixels included in the image sensor, the first pattern 410 of FIG. 4 is repeatedly arranged.

The preprocessor 110 may generate a region of interest having a preset size based on the received pixel values. The preprocessor 110 may calculate gradient values of pixels included in the region of interest. The gradient values may be calculated for preset directions, respectively. The preprocessor 110 may sum the gradient values of the pixels, and may determine a direction in which the sum of the gradient values is the smallest, among the preset directions, to be an interpolation direction in the region of interest.

The preset directions may include diagonal directions. For example, the preprocessor 110 may determine the northeast direction to be the interpolation direction in the region of interest. Similarly, the northwest direction, the southeast direction, or the southwest direction may be determined to be the interpolation direction in the region of interest. In an embodiment of the present disclosure, it may be assumed that the preprocessor 110 determines any one of diagonal directions to be the interpolation direction in the region of interest.

The pixel interpolator 120 may determine a first target pixel on which a white interpolation operation is to be performed in the region of interest. The first target pixel may be any one of color pixels that are non-white pixels. For example, the first target pixel may be a green pixel, a red pixel, or a blue pixel.

The pixel interpolator 120 may determine a second target pixel corresponding to a diagonal interpolation direction in the region of interest based on the first target pixel. The pixel interpolator 120 may determine a pixel closest to the first target pixel, among pixels corresponding to the diagonal interpolation direction, to be the second target pixel. The color of the first target pixel and the color of the second target pixel may be different from each other. The pixel interpolator 120 may convert the pixel value of the second target pixel into a conversion pixel value corresponding to the color of the first target pixel.

The pixel interpolator 120 may perform a white interpolation operation based on the ratio of the pixel values of white pixels to the pixel values of pixels corresponding to the color of the first target pixel. The pixel interpolator 120 may calculate the interpolated white pixel value of the first target pixel based on the ratio of the pixel values of adjacent white pixels adjacent to the first target pixel and the second target pixel to pixel values corresponding to the color of the first target pixel. In detail, the pixel interpolator 120 may calculate a first summed pixel value of the adjacent white pixels and a second summed pixel value of the first target pixel and the second target pixel. The second summed pixel value may be the sum of the pixel value of the first target pixel and the converted pixel value of the second target pixel.

The pixel interpolator 120 may calculate a value obtained by multiplying the pixel value of the first target pixel by a value, which is obtained by dividing the first summed pixel value by the second summed pixel value, as the interpolated white pixel value of the first target pixel. When the color of the first target pixel is identical to the color of the second target pixel, the converted pixel value of the second target pixel may be identical to the pixel value of the second target pixel.

When the color of the first target pixel is different from the color of the second target pixel, the pixel interpolator 120 may calculate the converted pixel value based on reference pixel values of reference pixels corresponding to the color and interpolation direction of the first target pixel, among neighboring pixels located near the second target pixel, and the distances between the second target pixel and the reference pixels. The pixel interpolator 120 may assign higher weights to the reference pixel values as the distances between the second target pixel and the reference pixels are shorter.

In an embodiment of the present disclosure, the pixel interpolator 120 may calculate the converted pixel value of the second target pixel based on the ratio of a third summed pixel value of first reference pixels corresponding to the color and the diagonal interpolation direction of the first target pixel, among the neighboring pixels of the second target pixel, to a fourth summed pixel value of second reference pixels corresponding to the color and the diagonal interpolation direction of the second target pixel, among the neighboring pixels of the second target pixel. The pixel interpolator 120 may calculate a value obtained by multiplying the pixel value of the second target pixel by a value, which is obtained by dividing the third summed pixel value by the fourth summed pixel value, as the converted pixel value of the second target pixel.

In an embodiment of the present disclosure, the pixel interpolator 120 may determine at least two reference pixels corresponding to the color and the diagonal interpolation direction of the first target pixel, among the neighboring pixels of the second target pixel. The pixel interpolator 120 may calculate a weighted average of the pixel values of the reference pixels, calculated based on the distances between the second target pixel and the reference pixels, as the converted pixel value of the second target pixel.

In an embodiment of the present disclosure, the pixel interpolator 120 may determine a pixel, which is closest to the first target pixel, among pixels having the same color as the first target pixel and corresponding to a diagonal interpolation direction, to be the second target pixel. The pixel interpolator 120 may assign weights to the pixel values of adjacent white pixels based on the distance between the first target pixel and the second target pixel, and may calculate the first summed pixel value and the second summed pixel value. Because the color of the first target pixel is always identical to the color of the second target pixel, the second summed pixel value may be the sum of the pixel values of the first target pixel and the second target pixel. The pixel interpolator 120 may calculate a value obtained by multiplying the pixel value of the first target pixel by a value, which is obtained by dividing the first summed pixel value by the second summed pixel value, as the interpolated white pixel value of the first target pixel.

FIG. 6 is a diagram for describing a white pixel interpolation operation corresponding to a diagonal interpolation direction in a region of interest according to an embodiment of the present disclosure.

Referring to FIG. 6, a region of interest having a 12*12 is be illustrated. In the region of interest, white pixels may be indicated by shaded portions.

It may be assumed that, among the pixels included in the region of interest, G45, which is a green pixel, is a first target pixel and a diagonal interpolation direction is the northwest direction. B34 may be determined to be a second target pixel based on G45 and the diagonal interpolation direction that is the northwest direction. Because the colors of G45 and B34 are different from each other, the pixel value of B34 may be converted. The converted pixel value G34 of the second target pixel B34 is represented as follows.

$$G 34 = \frac{p 23 + p 45}{2}$$

Here, p23 may be the pixel value of G23, and p45 may be the pixel value of G45. An interpolated white pixel value W45NW in the northwest direction of G45, which is the first target pixel, is represented by the following equation.

$$W 45 NW = \frac{p 55 + p 46 + ( p 35 + p 44 ) * 2 + p 24 + p 33}{p 45 + G 34} \cdot p 45$$

Here, p55, p46, p35, p44, p24, and p33 may be the pixel values of pixels W55, W46, W35, W44, W24, and W33.

When G45 is the first target pixel, the diagonal interpolation direction may be assumed to be the northeast direction. G36 may be determined to be the second target pixel based on G45 and the diagonal interpolation direction that is the northeast direction. Because the colors of G45 and G36 are identical to each other, the pixel value of G36 may be added without being converted. An interpolated white pixel value W45NE in the northeast direction of G45, which is the first target pixel, is represented by the following equation.

$$W 45 NE = \frac{p 44 + p 55 + ( p 35 + p 46 ) * 2 + p 26 + p 37}{p 45 + p 36} \cdot p 45$$

Here, p44, p46, p26, and p37 may be the pixel values of pixels W44, W46, W26 and W37, and p36 may be the pixel value of the pixel G36.

When G45 is the first target pixel, the diagonal interpolation direction may be assumed to be the southwest direction. G54 may be determined to be the second target pixel based on G45 and the diagonal interpolation direction that is the southwest direction. Because the colors of G45 and G54 are identical to each other, the pixel value of G54 may be added without being converted. An interpolated white pixel value W45SW in the southwest direction of G45, which is the first target pixel, is represented by the following equation.

$$W 45 SW = \frac{p 35 + p 46 + ( p 44 + p 55 ) * 2 + p 53 + p 64}{p 45 + p 54} \cdot p 45$$

Here, p53 and p64 may be the pixel values of pixels W53 and W64, and p54 may be the pixel value of the pixel G54.

When G45 is the first target pixel, the diagonal interpolation direction may be assumed to be the southeast direction. R56 may be determined to be the second target pixel based on G45 and the diagonal interpolation direction that is the southeast direction. Because the colors of G45 and R56 are different from each other, the pixel value of R56 may be converted. The converted pixel value G56 of the second target pixel R56 is represented as follows.

$$G 56 = \frac{p 45 + p 67}{2}$$

Here, p45 may be the pixel value of G45, and p67 may be the pixel value of G67. An interpolated white pixel value W45SE in the southeast direction of G45, which is the first target pixel, is represented by the following equation.

$$W 45 SE = \frac{p 35 + p 44 + ( p 46 + p 55 ) * 2 + p 57 + p 66}{p 45 + G 56} \cdot p 45$$

Here, p57 and p66 may be the pixel values of pixels W57 and W66.

It may be assumed that, among the pixels included in the region of interest, R56, which is a red pixel, is a first target pixel and a diagonal interpolation direction is the northwest direction. G45 may be determined to be a second target pixel based on R56 and the diagonal interpolation direction that is the northwest direction. Because the colors of R56 and G45 are different from each other, the pixel value of G45 may be converted. The converted pixel value R45 of the second target pixel G45 is represented as follows.

$$R 45 = \frac{p 01 + p 23 + p 45 + p 67}{( p 12 + p 56 ) * 2} \cdot p 45$$

Here, p01, p23, p45, and p67 may be the pixel values of pixels G01, G23, G45, and G67, and p12 and p56 may be the pixel values of pixels R12 and R56.

In an embodiment of the present disclosure, reference pixels corresponding to the color and the northwest direction of the first target pixel R56, among the neighboring pixels of the second target pixel G45, may be R12 and R56. The converted pixel value R45 of the pixel G45 may be a weighted average of the pixel values of the reference pixels, calculated based on the distances between the second target pixel G45 and the reference pixels. The converted pixel value R45 of the second target pixel G45 is represented as follows.

$$R 45 = \frac{p 12 + p 56 * 3}{4}$$

Because the reference pixel R56 is closer to the second target pixel G45 than the reference pixel R12, a weight may be assigned to the reference pixel R56. An interpolated white pixel value W56NW in the northwest direction of R56, which is the first target pixel, is represented by the following equation.

$$W 56 NW = \frac{p 57 + p 66 + ( p 46 + p 55 ) * 2 + p 35 + p 44}{p 56 + R 45} \cdot p 56$$

Here, p57, p66, p46, p55, p35, and p44 may be the pixel values of pixels W57, W66, W46, W55, W35, and W44.

When R56 is the first target pixel, the diagonal interpolation direction may be assumed to be the northeast direction. R47 may be determined to be the second target pixel based on R56 and the diagonal interpolation direction that is the northeast direction. Because the colors of R56 and R47 are identical to each other, the pixel value of R47 may be added without being converted. An interpolated white pixel value W56NE in the northeast direction of R56, which is the first target pixel, is represented by the following equation.

$$W 56 NE = \frac{p 55 + p 66 + ( p 46 + p 57 ) * 2 + p 37 + p 48}{p 56 + R 47} \cdot p 56$$

Here, p37 and p48 may be the pixel values of pixels W37 and W48, and p47 may be the pixel value of the pixel R47.

When R56 is the first target pixel, the diagonal interpolation direction may be assumed to be the southwest direction. B65 may be determined to be the second target pixel based on R56 and the diagonal interpolation direction that is the southwest direction. Because the colors of R56 and B65 are different from each other, the pixel value of B65 may be converted. The converted pixel value R65 of the second target pixel B65 is represented as follows.

$$R 65 = \frac{p 83 + p 56}{p 74 + p 65} * p 65$$

Here, p83 and p56 may be the pixel values of pixels R83 and R56, and p74 and p65 may be the pixel values of pixels B74 and B65. An interpolated white pixel value W56SW in the southwest direction of R56, which is the first target pixel, is represented by the following equation.

$$W 56 SW = \frac{p 46 + p 57 + ( p 55 + p 66 ) * 2 + p 64 + p 75}{p 56 + R 65} \cdot p 56$$

Here, p64 and p75 may be the pixel values of pixels W64 and W75.

When R56 is the first target pixel, the diagonal interpolation direction may be assumed to be the southeast direction. G67 may be determined to be the second target pixel based on R56 and the diagonal interpolation direction that is the southeast direction. Because the colors of R56 and G67 are different from each other, the pixel value of G67 may be converted. The converted pixel value R67 of the second target pixel G67 is represented as follows.

$$R 67 = \frac{p 45 + p 67 + p 89 + pab}{( p 56 + p 9 a ) * 2} \cdot p 67$$

Here, p45, p67, p89, and pab may be the pixel values of pixels G45, G67, G89, and Gab, and p56 and p9a may be the pixel values of pixels R56 and R9a.

In an embodiment of the present disclosure, the converted pixel value of the pixel G67 may be a weighted average of the pixel values of the reference pixels R56 and R9a. The converted pixel value R67 of the second target pixel G67 is represented as follows.

$$R 67 = \frac{p 9 a + p 56 * 3}{4}$$

In an embodiment of the present disclosure, the pixel interpolator may calculate the interpolated white pixel value of the first target pixel based on the ratio of the pixel values of white pixels and color pixels even in the case where no white pixels are present in the diagonal interpolation direction of the first target pixel.

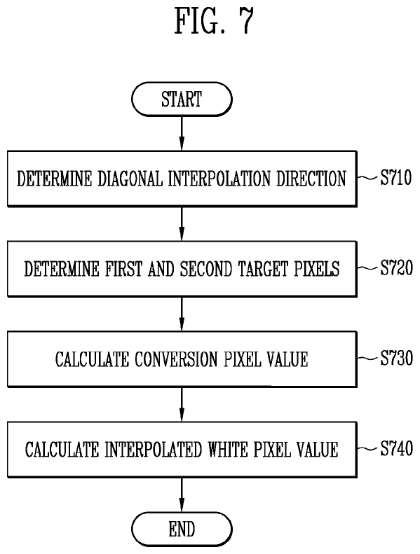

FIG. 7 is a flowchart illustrating a method of calculating an interpolated white pixel value according to an embodiment of the present disclosure.

Referring to FIG. 7, the image processing device may calculate a white pixel interpolation value corresponding to a diagonal direction even in the case where no white pixels are present in the diagonal direction of pixels included in a region of interest. The image processing device may perform a white interpolation operation based on the ratios of the pixel values of white pixels and color pixels between adjacent pixels being identical to each other.

At step S710, the preprocessor may determine a diagonal interpolation direction among diagonal directions, based on gradient values in preset diagonal directions in the region of interest. The preprocessor may calculate gradient values of respective pixels included in the region of interest. The preprocessor may determine a direction, in which the sum of the calculated gradient values is the smallest, to be an interpolation direction in the region of interest.

At step S720, the pixel interpolator may determine a second target pixel corresponding to the diagonal interpolation direction based on a first target pixel included in the region of interest. The pixel interpolator may determine a pixel closest to the first target pixel, among pixels corresponding to the diagonal interpolation direction, to be the second target pixel.

At step S730, the pixel interpolator may convert the pixel value of the second target pixel into a conversion pixel value corresponding to the color of the first target pixel. The pixel interpolator might not convert the pixel value of the second target pixel when the color of the first target pixel is identical to the color of the second target pixel. When the color of the first target pixel is different from the color of the second target pixel, the pixel interpolator may calculate the converted pixel value of the second target pixel based on the ratio of color pixel values of the first target pixel being identical to the ratio of color pixel values of the second target pixel.

At step S740, the pixel interpolator may calculate the interpolated white pixel value of the first target pixel based on the ratio of a first summed pixel value that is the sum of the pixel values of adjacent white pixels adjacent to the first target pixel and the second target pixel to a second summed pixel value that is the sum of the pixel value of the first target pixel and the converted pixel value.

Respective steps in FIG. 7 may correspond to descriptions of FIGS. 5 and 6.

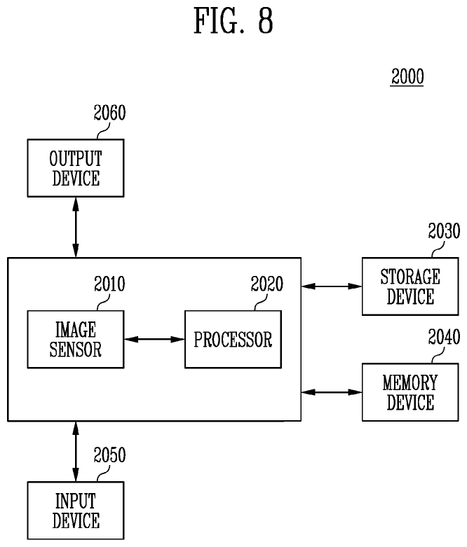

FIG. 8 is a block diagram illustrating an electronic device including an image processing device according to an embodiment of the present disclosure.

Referring to FIG. 8, an electronic device 2000 may include an image sensor 2010, a processor 2020, a storage device 2030, a memory device 2040, an input device 2050, and an output device 2060. Although not illustrated in FIG. 8, the electronic device 2000 may further include ports capable of communicating with a video card, a sound card, a memory card, or a universal serial bus (USB) device, or communicating with other electronic devices.

The image sensor 2010 may generate image data corresponding to incident light. In an embodiment of the present disclosure, the image sensor 2010 may include white pixels. The pixels included in the image sensor 2010 may include white pixels that are not arranged in a diagonal direction. The image data may be transferred to and processed by the processor 2020. The output device 2060 may display the image data. The storage device 2030 may store the image data. The processor 2020 may control the operations of the image sensor 2010, the output device 2060, and the storage device 2030.

The processor 2020 may be an image processing device which performs an operation of processing the image data received from the image sensor 2010 and outputs the processed image data. Here, processing may include electronic image stabilization (EIS), interpolation, tonal (hue) correction, image quality correction, size adjustment (resizing), etc.

In an embodiment of the present disclosure, the processor 2020 may determine a target pixel set, among a plurality of auto-focusing (self-focusing) pixel sets, based on the average values and variance values of pixel values output from a plurality of pixels corresponding to a kernel that is set based on each of the plurality of auto-focusing pixel sets. The processor 2020 may change pixel values of the target pixel set to virtual normal pixel values, and may correct the virtual normal pixel values based on neighboring pixel values. The processor 2020 may correct the pixel values of the target pixel set to correspond to the pattern of a color filter array included in the image sensor 2020. The processor 2020 may reduce noise occurring in an image by correcting auto-focusing pixel values.

The processor 2020 may be implemented as a chip independent of the image sensor 2010. For example, the processor 2020 may be implemented as a multi-chip package. In an embodiment of the present disclosure, the processor 2020 and the image sensor 2010 may be integrated into a single chip so that the processor 2020 is included as a part of the image sensor 2010.

The processor 2020 may execute and control the operation of the electronic device 2000. In accordance with an embodiment of the present disclosure, the processor 2020 may be a microprocessor, a central processing unit (CPU), or an application processor (AP). The processor 2020 may be coupled to the storage device 2030, the memory device 2040, the input device 2050, and the output device 2060 through an address bus, a control bus, and a data bus, and may then communicate with the devices.

The storage device 2030 may include all types of nonvolatile memory devices including a flash memory device, a solid state drive (SSD), a hard disk drive (HDD), and a CD-ROM.

The memory device 2040 may store data required for the operation of the electronic device 2000. For example, the memory device 2040 may include volatile memory such as a dynamic random-access memory (DRAM) or a static random-access memory (SRAM), or nonvolatile memory such as erasable programmable read-only memory (EPROM), electrically erasable programmable read-only memory (EEPROM), or flash memory. The processor 2020 may control the image sensor 2010 and the output device 2060 by executing an instruction set stored in the memory device 2040.

The input device 2050 may include an input means such as a keyboard, a keypad, or a mouse, and the output device 2060 may include an output means such as a printer device or a display.

The image sensor 2010 may be implemented as various types of packages. For example, at least some components of the image sensor 2010 may be implemented using any of packages such as package on package (POP), ball grid arrays (BGAs), chip scale packages (CSPs), plastic leaded chip carrier (PLCC), plastic dual in line package (PDIP), die in waffle pack, die in wafer form, chip on board (COB), ceramic dual in line package (CERDIP), plastic metric quad flat pack (MQFP), thin quad flatpack (TQFP), small outline integrated circuit (SOIC), shrink small outline package (SSOP), thin small outline package (TSOP), system in package (SIP), multi-chip package (MCP), wafer-level fabricated package (WFP), and wafer-level processed stack package (WSP).

Meanwhile, the electronic device 2000 may be construed as any of all computing systems using the image sensor 2010. The electronic device 2000 may be implemented in the form of a packaged module, a part or the like. For example, the electronic device 2000 may be implemented as a digital camera, a mobile device, a smartphone, a personal computer (PC), a tablet PC, a notebook computer, a personal digital assistant (PDA), an enterprise digital assistant (EDA), a portable multimedia player (PMP), a wearable device, a black box, a robot, an autonomous vehicle, or the like.

According to the present disclosure, there may be provided an image processing device and a pixel interpolation method, which enable an interpolation operation to be performed even when it is difficult to perform interpolation due to the absence of pixel values to be used for an interpolation operation. With the performance of the interpolation operation, the quality of an image may be improved.

It should be noted that the scope of the present disclosure is defined by the accompanying claims, rather than by the foregoing detailed descriptions, and all changes or modifications derived from the meaning and scope of the claims and equivalents thereof are included in the scope of the present disclosure.

What is claimed is:

1. An image processing device, comprising:
a preprocessor configured to generate a region of interest having a preset size based on pixel values received from an image sensor including white pixels and configured to determine an interpolation direction in the region of interest; and
a pixel interpolator configured to determine a second target pixel corresponding to the interpolation direction based on a first target pixel included in the region of interest and configured to calculate an interpolated white pixel value of the first target pixel based on a ratio of pixel values of adjacent white pixels adjacent to the first target pixel and the second target pixel to pixel values corresponding to a color of the first target pixel.

2. The image processing device according to claim 1, wherein the pixel interpolator is configured to calculate a value obtained by multiplying the pixel value of the first target pixel by a value, which is obtained by dividing a sum of pixel values of the adjacent white pixels by a sum of the pixel values of the first target pixel and the second target pixel, as the interpolated white pixel value, when the color of the first target pixel is identical to a color of the second target pixel.

3. The image processing device according to claim 1, wherein the pixel interpolator is configured to convert the pixel value of the second target pixel into a conversion pixel value corresponding to the color of the first target pixel, when the color of the first target pixel is different from a color of the second target pixel.

4. The image processing device according to claim 3, wherein the pixel interpolator is configured to calculate the conversion pixel value based on reference pixel values of reference pixels corresponding to the color and the interpolation direction of the first target pixel, among neighboring pixels located near the second target pixel, and based on distances between the second target pixel and the reference pixels.

5. The image processing device according to claim 4, wherein the pixel interpolator is configured to assign higher weights to the reference pixel values as the distances between the second target pixel and the reference pixels become shorter.

6. The image processing device according to claim 1, wherein the preprocessor is configured to determine the interpolation direction among preset directions of pixels included in the region of interest, based on gradient values in the preset directions.

7. The image processing device according to claim 1, wherein the preprocessor is configured to determine any one of diagonal directions to be the interpolation direction.

8. An image processing device, comprising:
a preprocessor configured to generate a region of interest having a preset size based on pixel values received from an image sensor including white pixels and configured to determine a diagonal interpolation direction in the region of interest among preset diagonal directions; and
a pixel interpolator configured to determine a second target pixel corresponding to the diagonal interpolation direction based on a first target pixel included in the region of interest and configured to calculate an interpolated white pixel value of the first target pixel based on a ratio of a first summed pixel value of adjacent white pixels adjacent to the first target pixel and the second target pixel to a second summed pixel value of the first target pixel and the second target pixel.

9. The image processing device according to claim 8, wherein the pixel interpolator is configured to determine a pixel closest to the first target pixel, among pixels having a color identical to that of the first target pixel and corresponding to the diagonal interpolation direction, to be the second target pixel, and configured to assign weights to pixel values of the adjacent white pixels based on a distance between the first target pixel and the second target pixel.

10. The image processing device according to claim 8, wherein the pixel interpolator is configured to determine a pixel closest to the first target pixel, among pixels corresponding to the diagonal interpolation direction, to be the second target pixel, and configured to convert a pixel value of the second target pixel into a conversion pixel value corresponding to the color of the first target pixel.

11. The image processing device according to claim 10, wherein:
the conversion pixel value is the pixel value of the second target pixel when the color of the first target pixel is identical to a color of the second target pixel, and
the pixel interpolator is configured to calculate a value obtained by multiplying the pixel value of the first target pixel by a value, which is obtained by dividing the first summed pixel value by the second summed pixel value, as the interpolated white pixel value.

12. The image processing device according to claim 10, wherein the pixel interpolator is configured to calculate the converted pixel value based on a ratio of a third summed pixel value of first reference pixels corresponding to the color and the diagonal interpolation direction of the first target pixel, among neighboring pixels located near the second target pixel, to a fourth summed pixel value of second reference pixels corresponding to a color and the diagonal interpolation direction of the second target pixel, among the neighboring pixels.

13. The image processing device according to claim 12, wherein the pixel interpolator is configured to calculate a value obtained by multiplying a pixel value of the second target pixel by a value, which is obtained by dividing the third summed pixel value by the fourth summed pixel value, as the converted pixel value.

14. The image processing device according to claim 10, wherein the pixel interpolator is configured to determine at least two reference pixels corresponding to the color and the diagonal interpolation direction of the first target pixel, among neighboring pixels located near the second target pixel, and to determine a weighted average of pixel values of the reference pixels calculated based on distances between the second target pixel and the reference pixels, to be the converted pixel value.

15. A white pixel interpolation method, comprising:
determining a diagonal interpolation direction among preset diagonal directions in a region of interest based on gradient values in the preset diagonal directions;
determining a second target pixel corresponding to the diagonal interpolation direction based on a first target pixel included in the region of interest;
converting a pixel value of the second target pixel into a conversion pixel value corresponding to a color of the first target pixel; and
calculating an interpolated white pixel value of the first target pixel based on a ratio of a first summed pixel value that is a sum of pixel values of adjacent white pixels adjacent to the first target pixel and the second target pixel to a second summed pixel value that is a sum of the pixel value of the first target pixel and the conversion pixel value.
